(19) United States
(12) Patent Application Publication
(10) Pub. No.: US 2023/0214452 A1
(43) Pub. Date: Jul. 6, 2023

(54) DWELL TIME RECORDING OF DIGITAL IMAGE REVIEW SESSIONS

(71) Applicant: Crosscope Inc., Mountain View, CA (US)

(72) Inventors: John Irvin Jackson, Brookfield, WI (US); Ketan Bacchuwar, Sunnyvale, CA (US); Jayendra Shinde, Sunnyvale, CA (US)

(21) Appl. No.: 17/566,993

(22) Filed: Dec. 31, 2021

(51) Int. Cl. G06K 9/62; G06F 40/205; G06T 7/11; G06F 3/0481

(52) U.S. Cl. CPC G06K 9/6257; G06K 9/6267; G06F 40/205; G06K 9/6253; G06T 7/11; G06F 3/0481; G06T 2200/24; G06T 2207/20021; G06T 2207/20081

(57) ABSTRACT

Systems and methods describe dwell time recording of digital image review sessions. The system displays, at a user interface (UI), a portion of an image on at least one monitor, where the image is segmented into a multitude of patches. The system then receives UI events involving a change in the currently displayed patches. For each of the UI events, the system records one or more dwell times representing durations for which the current patches of the image were displayed. The system also receives a report associated with the image review session, and processes the text of the report to determine a classification label for the image. Finally, the system trains a machine learning model, using at least the recorded dwell times and the classification label for the image.

### FIELD

The presently described systems and methods relate generally to the field of image processing, and more particularly, to providing for dwell time recording of digital image review sessions.

### BACKGROUND

Some images, such as, e.g., many digital pathology images, microscopy images, telescopic images, or geospatial imagery, contain more pixels than can be displayed on a single monitor at a single time at the monitor's highest possible resolution. For example, digital scans of a full pathology slide may be on the order of several gigabytes in size. A single screen, even at a high resolution, may be only capable of displaying a small fraction of such an image. These images may be favored by professionals needing to perform a close visual assessment of the image, because they provide for a very high level of detail and accuracy for each portion of the image. For example, a pathologist may need to carefully review a tissue biopsy image to rule out the presence of any cancer cells anywhere within that image.

Some artificial intelligence (hereinafter “AI”) models for such large images require labeled images for developing and training the model. One label that may be useful is the amount of interest or diagnostic significance that a particular region has. However, manually annotating these large images with such labels for regions requires additional time and effort by highly trained specialists.

Thus, there is a need in the field of image processing to create a new and useful system and method for intelligently providing such labels and related data without the need for any additional time nor effort expended by a specialist engaged in an image review session for the image. The source of the problem, as discovered by the inventors, is a lack of automatically determined labels for training data fed to AI models, which in turn is due to lack of accurate recording, analysis, and assessment of image review sessions.

### SUMMARY

The systems and methods described herein provide for dwell time recording for digital image review sessions. In one embodiment, the system displays, at a user interface (hereinafter “UI”) for an image review session, a portion of an image on at least one monitor, where the monitor cannot display the entirety of the image, and where the image is segmented into a multitude of patches representing regions of the image (e.g., square regions or other suitably segmented regions). The system then receives a number of UI events, each involving a change in the displayed patches of the image. For each of the received UI events, the system records one or more dwell times representing durations for which the current patches of the image are displayed. The system also receives a report associated with the image review session, and processes the text of the report to determine a classification label for the image. Finally, the system trains a machine learning model, using at least the recorded dwell times and the classification label for the image, to determine areas of interest within the image.

The features and components of these embodiments will be described in further detail in the description which follows. Additional features and advantages will also be set forth in the description which follows, and in part will be implicit from the description, or may be learned by the practice of the embodiments.

### BRIEF DESCRIPTION OF THE DRAWINGS

FIG. 1A is a diagram illustrating an exemplary environment in which some embodiments may operate.

FIG. 1B is a diagram illustrating an exemplary computer system that may execute instructions to perform some of the methods therein.

FIG. 2 is a flow chart illustrating an exemplary method that may be performed in accordance with some embodiments.

FIG. 3 is a flow chart illustrating an exemplary method that may be performed in accordance with some embodiments.

FIG. 4 is an image illustrating an example embodiment of an image used within an image review session that is segmented into patches, in accordance with some aspects of the systems and methods herein.

FIG. 5 is an image illustrating an example embodiment of an image used within an image review session's user interface that is segmented into patches, in accordance with some aspects of the systems and methods herein.

FIG. 6 is a diagram illustrating an exemplary computer that may perform processing in some embodiments.

### DETAILED DESCRIPTION

In this specification, reference is made in detail to specific examples of the systems and methods. Some of the examples or their aspects are illustrated in the drawings.

For clarity in explanation, the systems and methods herein have been described with reference to specific examples, however it should be understood that the systems and methods herein are not limited to the described examples. On the contrary, the systems and methods described herein cover alternatives, modifications, and equivalents as may be included within their respective scopes as defined by any patent claims. The following examples of the systems and methods are set forth without any loss of generality to, and without imposing limitations on, the claimed systems and methods. In the following description, specific details are set forth in order to provide a thorough understanding of the systems and methods. The systems and methods may be practiced without some or all of these specific details. In addition, well known features may not have been described in detail to avoid unnecessarily obscuring the systems and methods.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

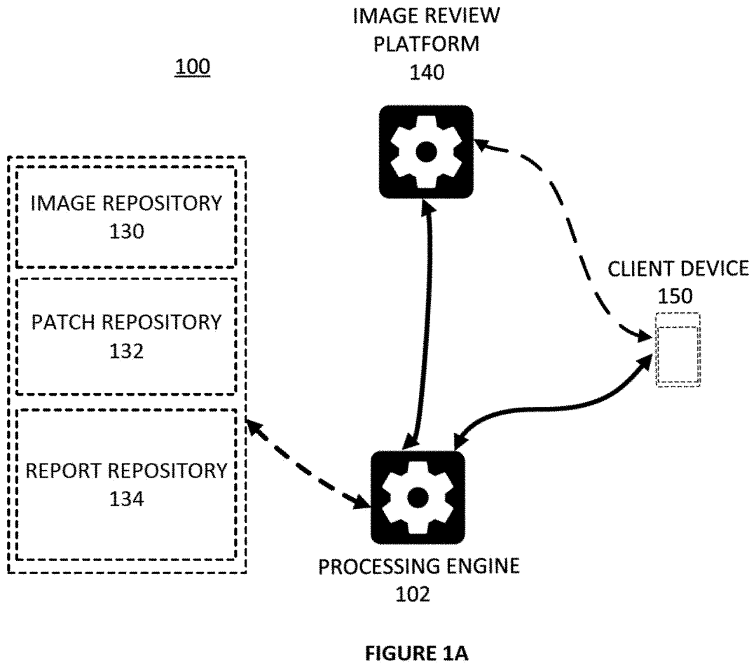

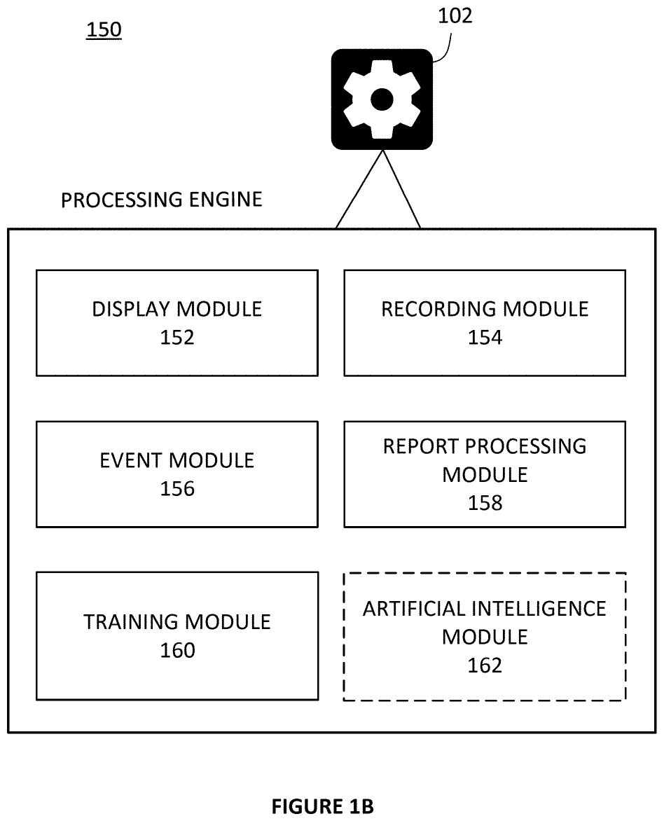

FIG. 1A is a diagram illustrating an exemplary environment in which some embodiments may operate. In the exemplary environment 100, a client device 120 is connected to a processing engine 102. The processing engine 102 is optionally connected to one or more optional database(s), including an image repository 130, patch repository 132, and/or report repository 134. One or more of the databases may be combined or split into multiple databases. The processing engine 102 is connected to an image review platform 140. The image review platform 140 and/or client device 120 in this environment may be computers or applications hosted on one or more computers.

The exemplary environment 100 is illustrated with only one client device and processing engine for simplicity, though in practice there may be more or fewer client devices and/or processing engines. In some embodiments, the client device and processing engine may be part of the same computer or device.

In an embodiment, the processing engine 102 may perform the method 200 or other method herein and, as a result, provide dwell time recording for image review sessions, as well as classification of the image to be used for training machine learning models. In some embodiments, this may be accomplished via communication with the client device, image review platform 140, and/or other device(s) over a network between the client device 120, image review platform 140, and/or other device(s) and an application server or some other network server. In some embodiments, the processing engine 102 is an application hosted on a computer or similar device, or is itself a computer or similar device configured to host an application to perform some of the methods and embodiments herein.

Client device 120 is a device that sends and receives information to the processing engine 102. In some embodiments, client device 120 is a computing device capable of hosting and executing one or more applications or other programs capable of sending and receiving information. In some embodiments, the client device 120 may be a computer desktop or laptop, mobile phone, virtual reality or augmented reality device, wearable, or any other suitable device capable of sending and receiving information. In some embodiments, the processing engine 102 may be hosted in whole or in part as an application executed on the client device 120.

Image review platform 140 refers to any platform which can facilitate a user, at client device 120, reviewing an image. The image review may be for professional purposes, such as a pathologist reviewing a patient's tissue images, or for any other suitable purpose. The platform may take the form of, e.g., an application which is maintained and executed on a computer device or multiple computer devices, or a cloud-based application which is hosted remotely (e.g., is executed via a browser application).

In various embodiments, one or more capture devices, sensors, or trackers may be used in conjunction with the client device 120. In some embodiments, one or more auxiliary biometric devices may be used in conjunction with the client device 120. In various embodiments, such biometric devices may include, for example, position sensors or accelerometers within a headset, or head, face, or eye tracking from a video camera. An eye tracking device, for example, may be configured to track the eye gaze of the user of the client device 120 as the user looks at various portions of the display during an image review session.

Optional database(s) including one or more of an image repository 130, patch repository 132, and/or report repository 134. These optional databases function to store and/or maintain, respectively, images to be reviewed in the session, patches or regions of the images, and reports, such as diagnostic reports, which may be associated with the images and/or sessions. The optional database(s) may also store and/or maintain any other suitable information for the processing engine 102 to perform elements of the methods and systems herein. In some embodiments, the optional database(s) can be queried by one or more components of system 100 (e.g., by the processing engine 102), and specific stored data in the database(s) can be retrieved.

FIG. 1B is a diagram illustrating an exemplary computer system that may execute instructions to perform some of the methods therein. The diagram shows an example of a processing engine 150. Processing engine 150 may be an example of, or include aspects of, the corresponding element or elements described with reference to FIG. 1A. In some embodiments, processing engine 150 is a component or system on an enterprise server. In other embodiments, processing engine 150 may be a component or system on client device 120, or may be a component or system on peripherals or third-party devices. Processing engine 150 may comprise hardware or software or both.

In the example embodiment, processing engine 150 includes display module 152, recording module 154, event module 156, report processing module 158, and training module 160.

Display module 152 functions to display, at a user interface (UI) for an image review session, a portion of an image on at least one monitor, where the monitor cannot display the entirety of the image, and where the image is segmented into a plurality of patches representing regions of the image.

Recording module 154 functions to record dwell times representing durations for which the current patches of the image are displayed, including recording dwell times when events are received for which new patches of the image are displayed.

Event module 156 functions to receive a number of UI events, each representing a change in the displayed patches of the image.

Report processing module 158 functions to receive a report associated with the image review session, then process the text of the report to determine a classification label for the image.

Training module 160 functions to train a machine learning model, using at least recorded dwell times and a classification label for the image, to determine areas of interest within the image.

In some embodiments, optional artificial intelligence module 158 functions to perform artificial intelligence tasks. In various embodiments, such tasks may include various machine learning, deep learning, and/or symbolic artificial intelligence tasks within the system. In some embodiments, artificial intelligence module may include training one or more artificial intelligence models. In some embodiments, multiple instance learning (MIL) may be used, as will be described in further detail below. In some embodiments, artificial intelligence module 158 may include decision trees such as, e.g., classification trees, regression trees, boosted trees, bootstrap aggregated decision trees, random forests, or a combination thereof. Additionally or alternatively, artificial intelligence module 158 may include neural networks (NN) such as, e.g., artificial neural networks (ANN), autoencoders, probabilistic neural networks (PNN), time delay neural networks (TDNN), convolutional neural networks (CNN), deep stacking networks (DSN), radial basis function networks (RBFN), general regression neural networks (GRNN), deep belief networks (DBN), deep neural networks (DNN), deep reinforcement learning (DRL), recurrent neural networks (RNN), fully recurrent neural networks (FRNN), Hopfield networks, Boltzmann machines, deep Boltzmann machines, self-organizing maps (SOM), learning vector quantizations (LVQ), simple recurrent networks (SRN), reservoir computing, echo state networks (ESN), long short-term memory networks (LSTM), bi-directional RNNs, hierarchical RNNs, stochastic neural networks, genetic scale models, committee of machines (CoM), associative neural networks (ASNN), instantaneously trained neural networks (ITNN), spiking neural networks (SNN), regulatory feedback networks, neocognitron networks, compound hierarchical-deep models, deep predictive coding networks (DPCN), multilayer kernel machines (MKM), cascade correlation networks (CCN), neuro-fuzzy networks, compositional pattern-producing networks, one-shot associative memory models, hierarchical temporal memory (HTM) models, holographic associative memory (HAM), neural Turing machines, or any combination thereof. In some embodiments, mathematical tools may also be utilized in performing artificial intelligence tasks, including metaheuristic processes such as, e.g., genetic processes, great deluge processes, and/or statistical tests such as Welch's t-tests or F-ratio tests. Any other suitable neural networks, mathematical tools, or artificial intelligence techniques may be contemplated.

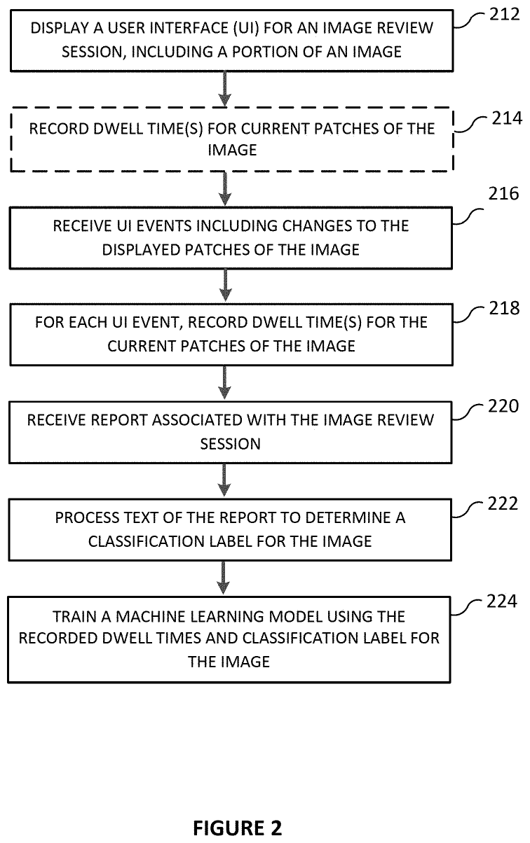

FIG. 2 is a flow chart illustrating an exemplary method that may be performed in accordance with some embodiments. The flow chart shows an example of a process for training a machine learning module using recorded dwell times and a classification label for an image. In some examples, these operations may be performed by a system including a processor executing a set of codes to control functional elements of an apparatus. Additionally or alternatively, the processes may be performed using special-purpose hardware. Generally, these operations may be performed in accordance with some aspects of the systems and methods herein. For example, the operations may be composed of various substeps, or may be performed in conjunction with other operations described herein.

At step 212, the system displays, at a user interface (UI) for an image review session, a portion of an image on at least one monitor, where the monitor cannot display the entirety of the image, and where the image is segmented into a multitude of patches representing regions of the image. In some embodiments, the UI and image are displayed at a client device associated with at least one user. In various embodiments, the system can receive or retrieve the image from, e.g., a client device, processing engine, local or remote database (e.g., a database located at a cloud server), or any other device, computer, engine, or repository. In some embodiments, the image review session is facilitated by or hosted on an image review platform, such as image review platform 140 in FIG. 1A. In some embodiments, the patches represent square regions of the image, while in other embodiments, the patches may represent rectangular regions, dynamically segmented regions based on one or more segmentation criteria, or any other suitably segmented regions.

In some embodiments, the image is received or retrieved having already been segmented into a multitude of patches representing regions of the image, which may be retrieved from, e.g., a database such as the patch repository 132 of FIG. 1A. In other embodiments, the system performs the segmentation of the image into multiple patches prior to displaying the image at the UI. Each “patch”, sometimes referred to as a tile, is a group of pixels representing a portion or region of the image (e.g., a square portion or region of the image). A patch may be, for example, a contiguous group of 256×256 pixels from the image. Some machine learning algorithms are configured to input images of or approximating this size for processing. For example, ImageNet inputs patches of 224×224 pixels for processing.

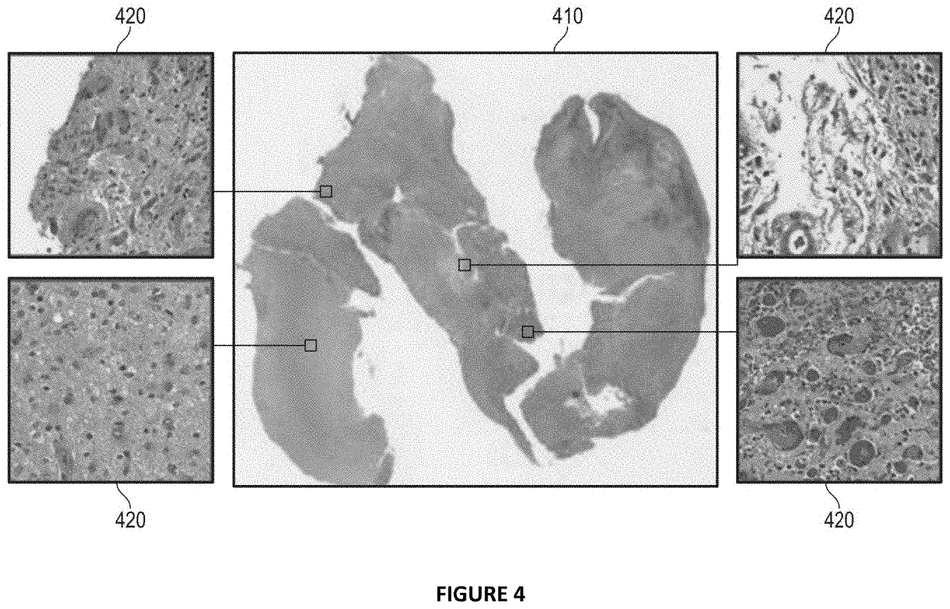

In some embodiments, the image is of a sufficiently large size that a monitor (e.g., connected to or part of a client device displaying the UI and the image) is not capable of displaying the entirety of the image at its current or maximum possible display resolution. For example, the image may be a very large digital pathology image constituting 200,000×200,000 pixels. A typical large monitor may have, for example, a 5,120×2,880 pixel display resolution. Such a monitor would require over 2,700 frames to display all of the large image, or over 45 minutes at a rate of 1 frame per second. One approach to processing an image to avoid such monitor constraints is to process each of a multitude of 782×782 pixel patches, then to perform additional downstream processing on the 600,000+ results. An example of an image and some of its patches is illustrated in FIG. 4, which is described in further detail below.

In some embodiments, an image may be stored in a pyramidal format, such as a .tif or .dzi format, which stores the image at multiple resolutions. The multiple resolutions may be, for example, a full resolution, ½×½ resolution (with one pixel representing 4 at the previous level), ¼×¼ resolution, and so on. Large images may require up to, e.g., 18 or 19 levels. With such a pyramidal format, the system can display selected regions at a selected magnification, such as in response to a user's input.

In some embodiments in which the image review sessions occur in a clinical context, the image may be a medical image. This may include, for example, a digital pathology image, a whole slide image (WSI), a tissue image, a per-surgery image, a post-surgery image, a medical microscopy image, a mammography image, a computed tomography (CT) scan image, x-ray images (for example, static/flexion/extension, with or without contrast agents), magnetic resonance imaging (MRI) images, ultrasound or invasive imaging such as scintigraphy, single-photon emission CT (SPECT/CT) X-ray angiography, intravascular ultrasound (IVUS), optical coherence tomography (OCT), near-infrared spectroscopy and imaging (NIRS), or any other suitable type of medical image. Image review sessions may occur within a particular clinical context, such as, e.g., digital histopathology, cytology, surgical pathology, or contexts related to, e.g., fecal, blood or other tissues, other human or non-human biologic tissues, or non-biologic objects. In other embodiments outside of a clinical context, the image may be a non-medical digital microscopy image, a telescopic image, a geospatial image, or any other suitable image.

At optional step 214 and in some embodiments, the system records one or more dwell times representing durations for which the current patches of the image are displayed. A “dwell time” constitutes a recorded value of a measure of time (i.e., a duration) for which a portion of a very large image is displayed on the screen. In some embodiments, a recording of a dwell time is meant to capture a time that the user has spent reviewing particular region(s), which can be compared to other dwell times in order to compare the times the user spent reviewing these different regions during the image review session. The dwell time recordings are stored for later retrieval by the system, such as in, e.g., a local or remote database. In some embodiments, the stored dwell time is analog in nature (though stored in digital format) or otherwise multi-valued, such that larger values indicate larger amounts of dwell time. In other embodiments, the stored dwell time is binary in nature, such that it can indicate whether the measure of dwell time for a particular patch has or has not exceeded a threshold.

In some embodiments, the dwell time for a region is a function of where the region is displayed within a display window of the UI. For example, regions displayed near or at the edge of the window may receive a lower weighting per second than regions displayed near or at the center of the window. This represents an assumption within the system that a user reviewing an image at a display will be more likely to display a region of the user's interest near or at the center of the display window than near or at the edge of the display window. The regions may be up- or down-weighted based on the baseline probability of display for any image in a certain class of images.

At step 216, the system receives a number of UI events, each representing a change in the displayed patches of the image. In various embodiments, UI events may include, e.g., registered user input enabling the user to pan across the image, zoom the image in or out, or a combination of both panning and zooming. One UI event may be of the user selecting a UI element to terminate the image review session, to switch to preparation of a diagnostic report, or some other event which may involving ending the display of some or all of the image. In some embodiments, the initial displaying of the image by the system is also recognized as a UI event. Any UI event which changes the portions of the image displayed (or displays initial portions of the image upon loading the image for the review session), changes the image itself, or ends display of the image may be contemplated.

At step 218, for each UI event received in step 216, the system records one or more dwell times representing durations for which the current patches of the image were displayed.

In some embodiments, the UI at which the image is displayed may include one or more UI elements which function to assist a user with reviewing all of an image. In some embodiments, one such UI element may constitute a UI control which may be used to limit panning of the image by the user to a single direction, such as, e.g., the horizontal or X-axis direction when using a mouse or other input device that is otherwise capable of capturing multi-dimensional (such as, e.g., two-dimensional) input. A different control, such as a mouse click or a keyboard control, may then be used to shift the displayed region of the image by a fixed or unfixed amount in the vertical or Y-axis direction. In this way, the UI control can facilitate the review of an entire slide.

For example, one UI element may only allow the user to pan the image left or right across the display, but not up or down, until a condition is satisfied such as, e.g., verification that all of a horizontal stripe of the slide has been reviewed, or verification that a different user interface control is used. After the condition is satisfied, then the display can move to another horizontal stripe, such as the neighboring stripe just above or below the previous stripe, potentially with some amount of overlap (e.g., 10% or 20% overlap) so that a small object will not just be seen near the edge of a window.

In some embodiments, the system keeps track of the locations of the pixels that are being displayed in order to determine how much of an image has been reviewed by the user during the review session. In some embodiments, the system can additionally keep track of the image resolution that is used for the display. In one example, a user reviewing an image may want to or need to review an entire slide at 5× resolution or higher resolution, and wants to ignore or disable reviewing of regions at lower resolutions. In some embodiments, the UI may include one or more elements or sections which allow the user to configure this constraint. Similarly, a reviewer may review much of an image at 5× or 10× resolution, then increase resolution to 20× or 40× for regions of significant diagnostic interest. Thus, in some embodiments, one or more resolution thresholds may be used to determine which regions have been adequately reviewed, or which regions have particular diagnostic interest.

In some embodiments, the system adjusts at least a subset of the recorded dwell times based on one or more adjustment rules. In various embodiments, this adjustment can be performed by the system during the image review session, or once the image review session has been completed or terminated. Such adjustments may include filtering out one or more dwell times, down-weighting them by a certain amount, up-weighting them by a certain amount, or otherwise decreasing or increasing the value of dwell time values. These adjustments may be the results of the system making certain inferences or assumptions regarding the user's engagement and activity with respect to portions or regions of the image during the review session. For example, a pathologist spending a longer time on one region or set of patches in particular within a tissue slide may indicate that the pathologist has identified the presence of cancer in that portion of the patient's tissue. The dwell time(s) associated with this region or these patches may therefore be adjusted upwards in relation to other regions or patches. Conversely, if the pathologist pans through a patch for only 1 second or less while panning towards a different region, the system may down-weight or lower the value of that patch because it was only incidentally displayed while the user sought out a different patch or set of patches.

In some embodiments, the system may filter out, down-weight, or otherwise lower the recorded dwell time value for regions that are viewed for lengthy periods of time when the system receives no indication, from one or more indicators, that the user is actively interacting with the computer or demonstrating active engagement within the image review session. For example, a reviewer may be interrupted while in the middle of a particular review session to answer a telephone call, go to lunch, or answer a question for a co-worker. In various embodiments, received indicators which can indicate such occurrences may include, for example, no mouse, trackpad, keyboard, or other input device events being received by the system for a period of time greater than a designated threshold. In various embodiments, this threshold may be fixed, may be selected by the user in a settings or preferences window of the UI, or may be learned by the system based on, e.g., the historical behavior of that particular reviewer or a set of reviewers. In some embodiments, if the reviewer is wearing or interfacing with an object, such as a headset or eye tracking device, then position sensors or accelerometers within the headset may be capable of sending indications of whether the reviewer is actively reviewing the image. If the device indicates that the review is not actively reviewing the image, then the system filters out, down-weights, or otherwise lowers the dwell time value(s) for the current region(s).

In some embodiments, one or more auxiliary biometric devices may be used to further refine which portions of a displayed image are of greatest interest or are getting the most attention, in order to up-weight, down-weight, filter out, or otherwise adjust the recorded dwell time values. Biometric devices may include, for example, position sensors or accelerometers within a headset, or head, face, or eye tracking from a video camera.

In some embodiments, in addition to or as an alternative to recording dwell times, the system may record regions based on the UI. In one example, the reviewer can use a mouse as a user interface device and employ a click-and-drag technique to pan the image display. This results in the user simply needing to move the mouse in order to move a cursor around the image. In some contexts, such mouse movements around portions of an image, in conjunction with dwell times which meet or exceed a threshold, such as 2, 5, or 10 seconds, may be indicative of a finding or area of interest, and the resulting cursor locations may be indicative of sub-regions of the image of greatest interest. Thus, the system may be configured to track or record such regions or sub-regions, and potentially assign values or weights to them in comparison to other regions or sub-regions.

In some embodiments, during a review of a tissue slide, a user may mark, flag, or annotate a region, for purposes such as including that image region in a diagnostic report (such as, e.g., a clinical report), to label a region for later teaching or consulting purposes, or for any other suitable purposes. Such marks, flags, or annotations, as well as their associated region, may alternately or additionally be used as classification labels and/or label data for purposes of AI model training (described with respect to step 224 below), without any additional effort being required by the reviewer.

In some embodiments, the system may receive one or more pieces of input data which have been supplied by the user during or after the review session to represent classification labels or label data. Some embodiments require or accept no such labeling or label data from the user and instead involve the system automatically determining labeling and/or label data, as will be described further below. Other embodiments, however, involve the system reviewing and processing such “minimal effort” labeling on the part of the user, and incorporating such labels or label data. In some embodiments, this processing may be performed during or at the end of an image review session, or at any other suitable time or location.

At step 220, the system receives a report associated with the image review session. The report may be any document with at least some textual content. The report may be associated with the image review session either directly, with the system identifying a connection between the report and the image review session, or indirectly or inferred, such as the system connecting the report to the user and the image review session to the user, with the report being completed by the user shortly after the image review session occurred.

In some embodiments, in addition to the report, the system additionally or alternatively receives patient data for the patient. In various embodiments, patient data may include invasive patient data such as, e.g., previously obtained data, per-surgery data and/or post-surgery data gathered through a medical procedure that requires a cut skin on the examined patient. This data may relate to, e.g., biological state, and/or inherited or acquired genetic characteristics. Additionally or alternatively, the patient data may include non-invasive data such as, e.g., patient conditions, biometric data, clinical examination data, wearable device data, or any other suitable patient data.

At step 222, the system processes the text of the report to determine a classification label for the image. In some embodiments, this processing includes, at least in part, natural language processing (hereinafter “NLP”) techniques to parse the textual content and extract, e.g., meaning, semantic analysis, and/or syntactic analysis from the report in order to determine a classification label for the image. For example, a classification label for a tissue slide may indicate that the presence of cancer was detected by the pathologist reviewing the slide. This may be inferred by processing the text of the report to determine the findings that the pathologist identified. In some embodiments, the report may be structured in some way, such as a synoptic pathology report. The system may use this structuring to enable the NLP techniques to process the text based on a more detailed set of information about the report.

In some embodiments, even though the report indicates that the image is negative for findings, the recorded dwell times may still be used to train an ML model to identify likely areas of interest within the image. For example, if a reviewer reports that a tissue slide is negative for findings, then the entire slide may be accordingly labelled. However, the dwell times may still be used to train an ML model that indicates likely areas of greatest diagnostic interest to a pathologist. One or a combination of models may thus present to a pathologist reviewing a tissue slide image that the ML model found the tissue associated with the image to be negative, but also highlight areas that may be of greatest interest to the pathologist who will still review the slide image to confirm or alter that ML model's finding.

In some embodiments, other users can review what previous users have looked at in the image to ensure or confirm why an ML model mislabeled an image. This may be presented to these other users in a separate UI intended for this process, or in a UI similar to or identical to the one presented to the original reviewer in the image review session. In some embodiments, such users may provide one or more corrections or labels which the ML model can potentially use to provide more accurate labeling for future images.

At step 224, the system trains a machine learning (hereinafter “ML”) model, using at least the recorded dwell times and the classification label for the image, to determine areas of interest within the image.

In one embodiment of the invention, one or more “multi-instance learning” (hereinafter “MIL”) techniques are used to train an MIL model. MIL is a variation of supervised learning wherein a single classification label is assigned to a bag of instances, and the MIL model is trained to predict the classification label for the bag. A bag is considered negative if all instances within the bag are negative, and positive if at least one instance is positive. When this is applied to, for example, a histopathology analysis and the training of a histopathologic MIL model, a whole slide image of tissue is considered negative if all regions, tiles, or patches within the slide are negative for clinical findings, but positive if at least one region, tile, or patch contains an image of pathologic tissue. This type of environment uses what is termed “weakly-supervised learning”, since labels are assigned to each bag of instances, rather than to the individual instances themselves. The performance of these models may be improved if the number of negative instances within positive bags can be reduced. In some embodiments, this can be achieved via utilization of the recorded dwell time values. In various embodiments, for images assigned a positive finding, bags consisting of only those regions, tiles, or patches that were displayed for any amount of time, were displayed for more than a threshold amount of time (e.g., 1 second, 5 seconds, or 10 seconds), were displayed for more than a relative amount of time (e.g., the regions that had the highest 5%, 20%, or 50% dwell times for that slide or case), or were displayed for a combination or weighting of absolute times and relative times may be used. In some embodiments, other dwell-time-related metrics may also be used.

In some embodiments, an optimal dwell time metric may be determined by incorporating an ML algorithm or other type of AI algorithm in order to generate a unique threshold for each user, type of image, type of image review session, or similar. For example, a unique threshold may be generated for a particular clinical pathologist, as well as for each type of tissue in the images that the pathologist reviews. With MIL, as with many types of ML, very high performance can still be achieved even if there are some errors in the training data set. Thus, even if the incorporation of dwell time recording occasionally leads to an error in classification or labeling, the overall effect may still be beneficial on the training of an ML model.

Within the context of training an ML model, a neural network can be considered to be a hardware or a software component that includes a number of connected nodes (a.k.a., artificial neurons), which may be seen as loosely corresponding to the neurons in a human brain. Each connection, or edge, may transmit a signal from one node to another (like the physical synapses in a brain). When a node receives a signal, it can process the signal and then transmit the processed signal to other connected nodes. In some embodiments, the signals between nodes comprise real numbers, and the output of each node may be computed by a function of the sum of its inputs. Each node and edge may be associated with one or more node weights that determine how the signal is processed and transmitted.

In some embodiments, during the training process for an ML model, the system may employ one or more ML models to adjust these weights in order to improve the accuracy of the result, such as by, e.g., minimizing a loss function which corresponds in some way to the difference between the current result and the target result. The weight of an edge may increase or decrease the strength of the signal transmitted between nodes. In some embodiments, nodes may have a threshold below which a signal is not transmitted at all. The nodes may also be aggregated into layers. Different layers may perform different transformations on their inputs. In some embodiments, the initial layer is the input layer and the last layer is the output layer. In some cases, signals may traverse certain layers multiple times.

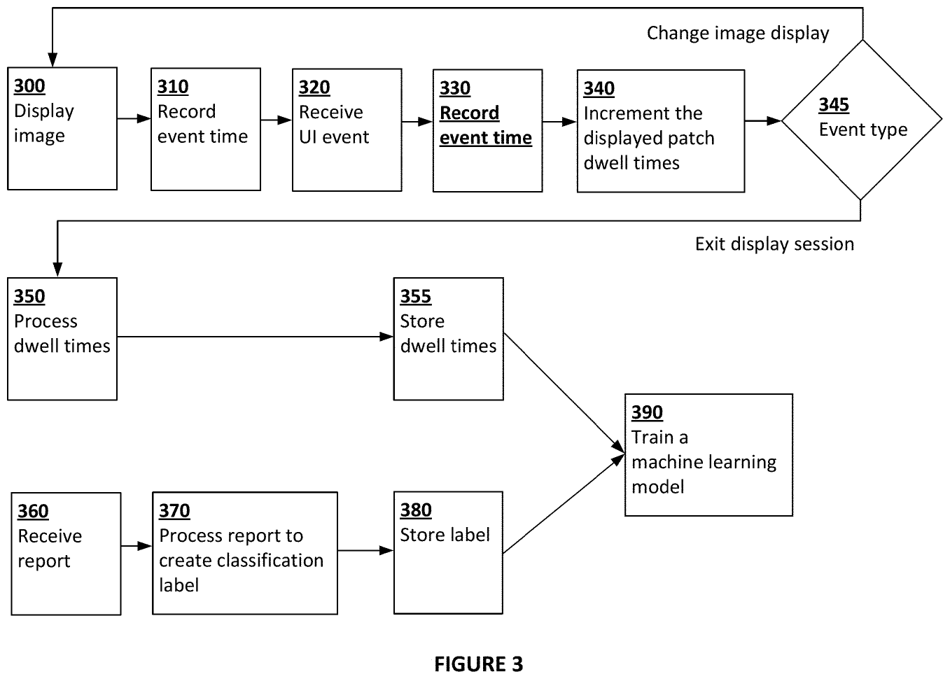

FIG. 3 is a flow chart illustrating an exemplary method that may be performed in accordance with some embodiments. The example illustrated in FIG. 3 and described below refers to a clinical pathology context, in which a pathologist reviews a digital pathology image and submits a diagnostic report. However, any suitable context may be substituted for FIG. 3 in place of this clinical pathology context.

At step 300, in response to a computer command, such as the selection of a slide from a list using a keyboard or mouse or other input device, an image or portion of an image is displayed. The image, for purposes of this example, is a digitized histopathology slide constituting a whole slide image (“WSI”) of a tissue sample stained with hematoxylin and eosin. The image may cover an entire computer monitor or a portion of the monitor, or the coverage may extend over multiple computer monitors, such as monitors that are positioned next to each other to generate an effectively larger monitor. Images of histopathology slides may consist of many more pixels than can be shown on a monitor, so only a portion of the WSI is shown. The image data may be shown at the highest resolution, or at any step-down resolution.

At step 310, the system records an event time value corresponding to when the current image started to be displayed. The event time value may be, for example, 12:00:00 indicating that the current image started to be displayed at 12 noon. This event time is stored as t0.

At step 320, the system receives a UI event to change the displayed image, such as, e.g., by panning, by zooming, or both, initially loading portions of the image, or by selecting a UI element to exit the image display session.

At step 330, the system records an event time value associated with the UI event from step 320. This event time is stored as t1.

At step 340, for each patch that has been displayed, the system increments a dwell time by t1-t0. The dwell time in this embodiment represents how long the currently displayed portions of the image are on the screen. The event time t0 represents the start time for when the portions began to be displayed, i.e., the time related to the start of the UI event is stored as t0. The event time t1 represents the end time for when the portions stopped being displayed. In one example where a set of patches are displayed on the screen starting at 12:00:00 and ending at 12:00:10, the system increments the dwell time by t1-t0, or 10 seconds. In some embodiments, the dwell time relates only to portions which are shown in the middle or center of the screen. Since the screen is bigger than just the middle or center patch, however, the system performs a convolution and spreads the dwell time recorded value out to the other portions displayed on the screen. In some embodiments the incrementing can be done in real time, while in other embodiments the system stores or records the UI events, and performs calculation of the dwell time in post-processing, after the image review session has terminated.

At decision point 345, if the UI event received from step 320 was to change the image display (e.g., by panning or zooming), the system reverts back to step 300, and additional dwell time(s) can be recorded for additional patches displayed. If the UI event was to end the display session, the system proceeds to step 350.

At step 350, the system processes the dwell times for the patches. For example, very large times, such as over an hour, may indicate that the pathologist left the displayed image on the computer while going to lunch, so may be replaced by a smaller time, such as 5 minutes. Very short times, such as less than one second, may be replaced with 0 seconds. Other adjustments may be made, potentially in conjunction with other computer-related events, such as, e.g., mouse movements, keyboard events, or images from a video camera being processed (such as for eye tracking).

At step 355, the system stores the dwell times in memory.

At step 360, most likely after the image review session has completed, the pathologist generates a diagnostic report related to the image review session, and the system receives this diagnostic report.

At step 370, the system processes this diagnostic report using one or more ML algorithms and/or techniques to determine a classification label for the whole slide. In a structured synoptic pathology report, for example, a positive or negative entry for a field such as “presence of cancer” may be used. In some instances, a more detailed classification label associated with a particular type of cancer may be used. A natural language processing model, such as, e.g., BERT, may be used to extract the classification label from the text of the diagnostic report.

At step 380, the system stores the classification label in memory.

At step 390, the stored dwell times from step 355 and the classification label from step 380 are jointly used to train an ML model. For example, when training an MIL model using MIL techniques, a collection or bag of instances is considered negative if all instances within the bag are negative, and positive if at least one instance is positive. For training this type of model, images with a “negative” label contain many patches which are all negative, and all of the patches within the image may be used as negative examples. Images with a “positive” label contain at least one “positive” patch. Traditionally, the MIL model would have had to consider that any of the patches within the image may have been positive. However, by also incorporating the dwell time values, one may consider that the positive patches must have come from the set of patches scrutinized by the pathologist, so only patches with a dwell time greater than a threshold time, such as 1 second or 5 seconds, may be placed in this “positive bag”. This greatly reduces the number of patches within this bag, which may help the ML model to train much more quickly or accurately.

In some alternate embodiments, instead of recording the dwell time for each patch as it is being displayed, the system records the dwell time of the most central tile for each display event, then, at the end of the display session, convolves the central point dwell times by the number of patches that were shown in the display window, such as 20 by 11, to get a dwell time for each individual tile.

In some alternate embodiments, instead of measuring dwell times for each patch during the display session, the dwell times are determined by processing an event log after the end of the display session.

In some alternate embodiments, instead of a single image constituting an individual slide being reviewed and processed in these steps, there may be a set of multiple slides associated with a single patient case, and the dwell times and classification label may be associated with the entire set of slides.

FIG. 4 is an image illustrating an example embodiment of an image used within an image review session that is segmented into patches, in accordance with some aspects of the systems and methods herein.

Within the illustrated example, a whole slide image 410 is reviewed within an image review session. The whole slide image 410 has been segmented into several regions, i.e., patches 420. In this illustrated example, the regions are square in shape. The entire image 410 cannot be displayed on a monitor that the reviewer is using. Thus, for the image review session, the system displays one or more of the patches of the whole slide at any given time the user is reviewing, rather than the whole slide itself. The user can pan or zoom to different regions of the slide, with different patches being displayed on the monitor. Dwell times are recorded representing how long the user dwells on various regions or patches displayed on the screen, as described above.

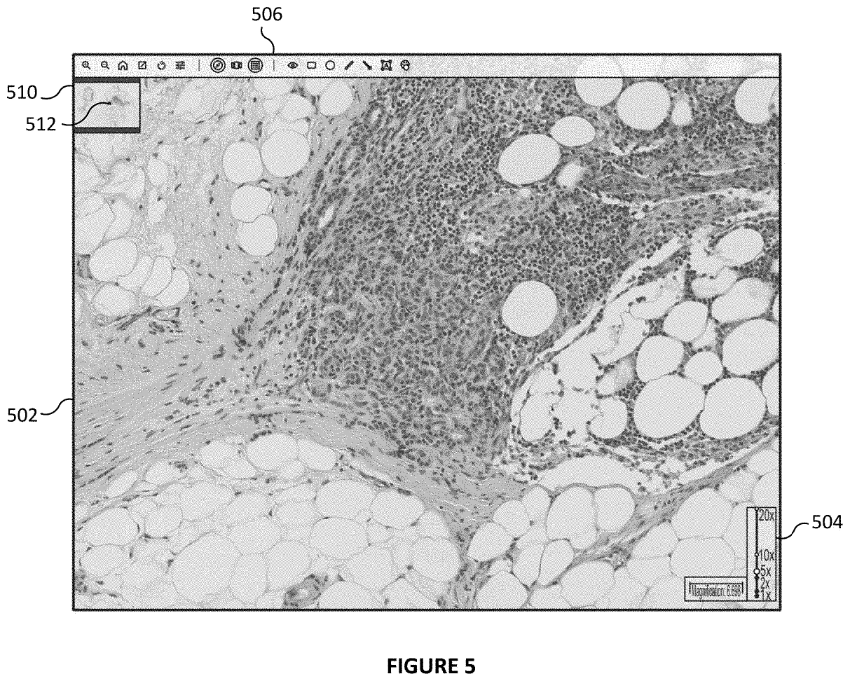

FIG. 5 is an image illustrating an example embodiment of an image used within an image review session's user interface that is segmented into patches, in accordance with some aspects of the systems and methods herein.

Within the illustrated embodiment, a pathologist is using a client device to review a whole slide image of a patient. The illustration shows a user interface displayed at the client device. The majority of the user interface window shown displays a portion 502 of the image in detail. The portion 502 includes one or more patches of the whole image slide. User interface elements 504 on the lower left of the screen allow the pathologist to adjust the degree of magnification of the image. This allows the pathologist to zoom the image in or out, which would respectively display a more detailed view of one or more patches of the image, or additional patches not currently displayed. At the top of the screen is a menu bar element 506 with a number of selectable menu options, including options to zoom in or out, navigate to a home screen, annotate a section of the image, and execute other actions. Below the menu bar on the left of the screen is a thumbnail image 510 which displays a small thumbnail of the full slide. Within the thumbnail, a small dot 512 indicates which specific portion of the image is currently shown, in detailed fashion, in the majority of the window. In some embodiments, the pathologist can click and drag around the screen to pan the display to other, adjacent portions and patches of the image. Additionally or alternatively, if the pathologist is using a touch screen interface that is configured for use with the image session, the pathologist may be able to touch the screen and swipe to pan around the image. In some embodiment, the pathologist may touch or click on anywhere within the small thumbnail image 504 to view the portion and patches corresponding to that location within the whole slide image.

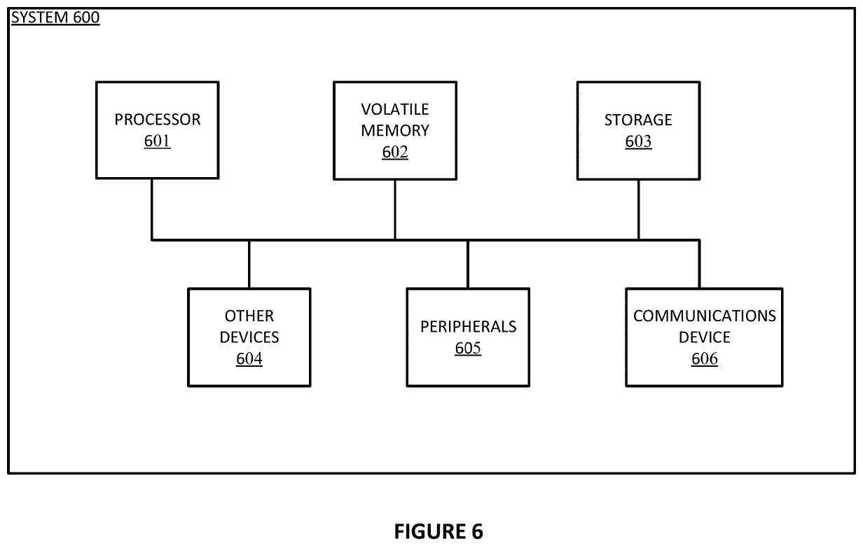

FIG. 6 is a diagram illustrating an exemplary computer that may perform processing in some embodiments. Exemplary computer 600 may perform operations consistent with some embodiments. The architecture of computer 600 is exemplary. Computers can be implemented in a variety of other ways. A wide variety of computers can be used in accordance with the embodiments herein. In some embodiments, cloud computing components and/or processes may be substituted for any number of components or processes illustrated in the example.

Processor 601 may perform computing functions such as running computer programs. The volatile memory 602 may provide temporary storage of data for the processor 601. RAM is one kind of volatile memory. Volatile memory typically requires power to maintain its stored information. Storage 603 provides computer storage for data, instructions, and/or arbitrary information. Non-volatile memory, which can preserve data even when not powered and including disks and flash memory, is an example of storage. Storage 603 may be organized as a file system, database, or in other ways. Data, instructions, and information may be loaded from storage 603 into volatile memory 602 for processing by the processor 601.

The computer 600 may include peripherals 605. Peripherals 605 may include input peripherals such as a keyboard, mouse, trackball, video camera, microphone, and other input devices. Peripherals 605 may also include output devices such as a display. Peripherals 605 may include removable media devices such as CD-R and DVD-R recorders/players. Communications device 606 may connect the computer 100 to an external medium. For example, communications device 606 may take the form of a network adapter that provides communications to a network. A computer 600 may also include a variety of other devices 604. The various components of the computer 600 may be connected by a connection medium 610 such as a bus, crossbar, or network.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed:

1. A method, comprising:
displaying, at a user interface (UI) for an image review session, a portion of an image on at least one monitor, wherein the monitor cannot display the entirety of the image, and wherein the image is segmented into a plurality of patches representing regions of the image;
receiving a plurality of UI events, each comprising a change in the displayed patches of the image;
for each of the received UI events, recording one or more dwell times representing durations for which the current patches of the image are displayed;
receiving a report associated with the image review session;
processing the text of the report to determine a classification label for the image; and
training a machine learning model, using at least the recorded dwell times and the classification label for the image, to determine areas of interest within the image.

2. The method of claim 1, further comprising:
receiving the image; and
determining that the entirety of the image cannot be displayed on the monitor at a current or maximum resolution.

3. The method of claim 1, further comprising:
segmenting the image into regions of a predetermined pixel size to extract the plurality of patches within the image.

3. The method of claim 1, further comprising:
for each of the received UI events, increment the dwell times for each of the displayed patches for that UI event.

4. The method of claim 1, further comprising:
adjusting at least a subset of the plurality of recorded dwell times based on one or more adjustment rules.

5. The method of claim 4, wherein the adjustment rules comprise one or more of: adjusting the recorded dwell time to a predefined time when the dwell time exceeds a threshold dwell time representing idle activity, adjusting the dwell time to zero seconds when the dwell time is less than a threshold dwell time representing insignificant activity, and adjusting the dwell time based on one or more received inputs.

6. The method of claim 1, further comprising:
receiving an indication of a termination of the image review session; and
stopping the current recordings of dwell times for the image review session.

7. The method of claim 1, wherein the machine learning model is trained using one or more multi-instance learning (MIL) techniques to group and classify the set of patches.

8. The method of claim 1, further comprising:
employing the machine learning model to provide the areas of interest to one or more permitted users.

9. The method of claim 1, further comprising:
providing a verification, based on the recorded dwell times and the classification label for the image, that the entirety or a determined sufficient amount of the image has been reviewed.

10. The method of claim 1, further comprising:
receiving one or more annotations associated with a region comprising at least a subset of one or more of the displayed patches; and
determining classification labels for the one of more of the displayed patches within the region based on the annotations associated with the region, wherein the classification labels for the patches are further used for training the machine learning model.

11. The method of claim 1, further comprising:
determining classification labels for at least a subset of the displayed patches based on one or more labeling criteria, wherein the classification labels for the patches are additionally used for training the machine learning model.

12. The method of claim 11, wherein the labeling criteria comprises classifying at least one patch as positive if the dwell time for the patch exceeds a threshold and the image is classified as positive.

13. The method of claim 11, further comprising:
generating one or more customized thresholds for dwell times associated with one or more of the image or a user associated with the image review session, wherein the unique thresholds are used to determine classification labels for the displayed patches.

14. The method of claim 1, wherein at least one of the UI events comprises panning or zooming to a different portion of the image within the UI.

15. The method of claim 1, wherein the recording of one or more dwell times representing durations for which the current patches of the image are displayed comprises recording a dwell time for the most centrally displayed patch of the patches displayed on the monitor, and further comprising:
determining a dwell time for each displayed patch in the image review session by convolving the central point dwell times by the number of patches displayed on the monitor.

16. The method of claim 1, further comprising:
receiving an event log for the image review session; and
adjusting or determining one or more dwell times based on the event log.

17. A non-transitory computer-readable medium containing instructions, comprising:
instructions for displaying, at a user interface (UI) for an image review session, a portion of an image on at least one monitor, wherein the monitor cannot display the entirety of the image, and wherein the image is segmented into a plurality of patches representing regions of the image;
instructions for receiving a plurality of UI events, each comprising a change in the displayed patches of the image;
for each of the received UI events, instructions for recording one or more dwell times representing durations for which the current patches of the image are displayed;
instructions for receiving a report associated with the image review session;
instructions for processing the text of the report to determine a classification label for the image; and
instructions for training a machine learning model, using at least the recorded dwell times and the classification label for the image, to determine areas of interest within the image.

18. The non-transitory computer-readable medium of claim 17, wherein recording dwell times is performed by capturing at least one of images and biometric information from an eye tracking device.

19. The non-transitory computer-readable medium of claim 17, wherein one or more of the recorded dwell times and the classification label for the image is in a binary format.

20. A system comprising one or more processors configured to perform the operations of:
displaying, at a user interface (UI) for an image review session, a portion of an image on at least one monitor, wherein the monitor cannot display the entirety of the image, and wherein the image is segmented into a plurality of patches representing regions of the image;
receiving a plurality of UI events, each comprising a change in the displayed patches of the image;
for each of the received UI events, recording one or more dwell times representing durations for which the current patches of the image are displayed;
receiving a report associated with the image review session;
processing the text of the report to determine a classification label for the image; and
training a machine learning model, using at least the recorded dwell times and the classification label for the image, to determine areas of interest within the image.
